(19) United States
(12) Patent Application Publication
(10) Pub. No.: US 2013/0023712 A1
(43) Pub. Date: Jan. 24, 2013

(54) METHOD OF REMOVING ACID COMPOUNDS FROM A GASEOUS EFFLUENT WITH AN ABSORBENT SOLUTION BASED ON I/II/III TRIAMINES

(71) Applicants: Fabien Porcheron, Mions (FR); Marc Jacquin, Lyon (FR); Bruno Delfort, Paris (FR); Dominique Le Pennec, Orgerus (FR); Julien Grandjean, Lyon (FR)

(72) Inventors: Fabien Porcheron, Mions (FR); Marc Jacquin, Lyon (FR); Bruno Delfort, Paris (FR); Dominique Le Pennec, Orgerus (FR); Julien Grandjean, Lyon (FR)

(21) Appl. No.: 13/515,340

(22) PCT Filed: Nov. 25, 2010
(86) PCT No.: PCT/FR10/00786

§ 371 Date: Sep. 24, 2012

(30) Foreign Application Priority Data
Dec. 16, 2009 (FR) 09/06.099

(51) Int. Cl. B01D 53/14

(52) U.S. Cl. 585/860

(57) ABSTRACT

The invention relates to the removal of acid compounds from a gaseous effluent in an absorption method using an aqueous solution containing one or more triamines wherein the three amine functions are not connected to each other by rings and whose amine functions in the a and the co positions are always tertiary, and the amine function in central position is always secondary, more or less sterically hindered, and which have the general formula (I) as follows:

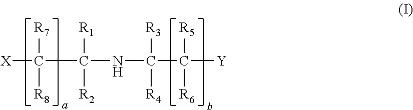

### CROSS-REFERENCE TO RELATED APPLICATIONS

Reference is made to French Patent Application 09/06.099, filed Dec. 16, 2009, and PCT Application FR2010/00786, filed Nov. 25, 2010, which applications are incorporated herein by reference in their entirety.

### BACKGROUND OF THE INVENTION

1. Field of the Invention

The present invention relates to the removal of acid compounds (H₂S, CO₂, COS, CS₂, mercaptans, etc.) from a gaseous effluent using an absorbent aqueous solution comprising triamines. The invention is advantageously applied to the treatment of gas of industrial origin and of natural gas.

2. Description of the Prior Art

Treatment of Gas of Industrial Origin

The nature of the gaseous effluents that can be treated is varied. Non-limitative examples thereof are syngas, combustion fumes, refinery gas, Claus tail gases, biomass fermentation gases, cement plant gases and blast furnace gases.

All of these gases contain acid compounds such as, for example, carbon dioxide (CO₂), hydrogen sulfide (H₂S), carbon oxysulfide (COS), carbon disulfide (CS₂) and mercaptans (RSH), mainly methylmercaptan (CH₃SH), ethylmercaptan (CH₃CH₂SH) and propylmercaptans (CH₃CH₂CH₂SH).

For example, in the case of combustion fumes, the gaseous effluent contains nitrogen, CO₂, oxygen and some sulfur-containing or nitrogen-containing impurities. CO₂ is the acid compound to be removed. In fact, carbon dioxide is one of the greenhouse gases widely produced by human activities and it has a direct impact on atmospheric pollution. In order to reduce the amounts of carbon dioxide discharged to the atmosphere, it is possible to capture the CO₂ contained in a gaseous effluent. By way of illustration, the goal of a post-combustion CO₂ capture unit is generally to reduce by 90% the CO₂ emissions of a thermal power plant. Decarbonation is generally carried out by washing the gas with an absorbent solution containing one or more amines.

Furthermore, in the case of syngas, the gaseous effluent contains carbon monoxide CO, hydrogen H₂, water vapour and carbon dioxide CO₂. It also comprises sulfur-containing impurities (H₂S, COS, etc.), nitrogen-containing impurities (NH₃, HCN) and halogenated impurities that have to be removed for the gas to eventually contain only residual proportions thereof. The impurities present in the non-purified syngas can cause accelerated corrosion of the plants and are likely to poison the catalysts used in chemical synthesis processes such as those used in the Fischer-Tropsch synthesis or methanol synthesis, or attenuate the performances of the materials used in fuel cells. Environmental considerations also require removing the impurities present in gases. In the particular case of Fischer-Tropsch synthesis, the specifications required at the inlet of the Fischer-Tropsch unit are particularly severe, and the proportions present in syngas must generally be less than 10 ppb weight for the sulfur-containing impurities. In order to reach such low sulfur-containing impurity contents, the gas is generally washed with an absorbent solution containing amines, combined with the use of capture masses.

Treatment of Natural Gas

The goal of deacidizing natural gas is to remove acid compounds such as carbon dioxide (CO₂), as well as hydrogen sulfide (H₂S), carbon oxysulfide (COS), carbon disulfide (CS₂) and mercaptans (RSH), mainly methylmercaptan (CH₃SH), ethylmercaptan (CH₃CH₂SH) and propylmercaptans (CH₃CH₂CH₂SH). The specifications generally used for deacidized gas are 2% CO₂, or even 50 ppm volume CO₂, the natural gas being thereafter subjected to liquefaction; 4 ppm H₂S and 10 to 50 ppm volume of total sulfur.

Deacidizing is therefore often carried out first, notably in order to remove the toxic acid gases such as H₂S in the first stage of the chain of processes and thus to avoid pollution of the various unit operations by these acid compounds, notably the dehydration section, the condensation and separation section intended for the heavier hydrocarbons. Deacidizing is generally carried out by washing the gas with an absorbent solution containing one or more amines.

Natural gases having all sorts of acid gas compositions can be found all over the world. Thus, there are gases containing mainly only H₂S or only CO₂, or these two gases in admixture. Besides, there are also natural gases very rich (up to 40 vol. %) or very poor (around one hundred ppm) in acid compounds. In addition to the constraints due to the nature of the gas to be treated, the operator in charge of deacidizing this gas also has to take account of transport specification constraints (2% CO₂ for transport by pipeline and 50 ppm volume for transport by boat after liquefaction) and constraints related to the other units of the gas processing chain (for example a Claus type plant converting the toxic H₂S to inert sulfur does not tolerate more than 65% CO₂). In order to meet all these constraints, the operator may have to carry out total deacidizing (CO₂ and H₂S), selective H₂S deacidizing, or deacidizing followed by a stage of H₂S enrichment of the acid gas.

Acid Compounds Removal by Absorption

Deacidizing gaseous effluents is generally carried out by washing with an absorbent solution. The absorbent solution allows absorption of the acid compounds present in the gaseous effluent (notably CO₂, H₂S, mercaptans, COS, CS₂).

The solvents commonly used today are aqueous solutions of primary, secondary or tertiary alkanolamine, in combination with an optional physical solvent. French Patent 2,820,430, which discloses gaseous effluent deacidizing methods, are mentioned by way of example. U.S. Pat. No. 6,852,144, which describes a method of removing acid compounds from hydrocarbons, is also mentioned for example. The method uses a water-methyldiethanolamine or water-triethanolamine absorbent solution containing a high proportion of a compound belonging to the following group: piperazine and/or methylpiperazine and/or morpholine.

U.S. Pat. No. 4,240,923 recommends using amines known as sterically hindered for removing acid compounds from a gaseous effluent. These amines notably afford advantages in terms of absorption capacity and regeneration energy. The structures described are notably piperidine-derived nitrogen-containing heterocycles where the a position of the nitrogen atom is hindered notably by an alkyl or alcohol group.

For example, in the case of CO₂ capture, the absorbed CO₂ reacts with the alkanolamine present in solution according to a reversible known exothermic reaction and leads to the formation of hydrogen carbonates, carbonates and/or carbamates, for allowing removal of the CO₂ from the gas to be treated.

Similarly, for the removal of H₂S from the gas to be treated, the absorbed H₂S reacts instantaneously with the alkanolamine present in solution according to a known reversible exothermic reaction and leads to the formation of hydrogen sulfide.

It is well known to the person skilled in the art that tertiary amines or secondary amines with severe steric hindrance have slower CO₂ capture kinetics than less hindered primary or secondary amines. On the other hand, tertiary or secondary amines with severe steric hindrance have instantaneous H₂S capture kinetics, which allows selective H₂S removal based on distinct kinetic performances (U.S. Pat. No. 4,405,581).

One limitation of the solvents commonly used today in total deacidizing applications is too slow CO₂ or COS capture kinetics. In cases where the CO₂ (or possibly COS) content of the raw gas is above the desired specifications and this acid gas is therefore to be removed, it is necessary to dimension the absorption column according to the reaction kinetics between the amine and the CO₂ (or possibly the COS). The slower the reaction kinetics, the greater the column height, all things being equal, knowing that there are several orders of magnitude between the reaction kinetics for a tertiary or highly sterically hindered amine, and a primary or secondary amine. This limitation is particularly great in the case of natural gas decarbonation or syngas desulfurization, since the absorption column is under pressure, and it therefore represents the major part of the investments.

Another limitation of the solvents commonly used today in selective H₂S deacidizing applications is too fast CO₂ capture kinetics. In fact, in some natural gas deacidizing cases, selective H₂S removal is sought by limiting to the maximum CO₂ absorption. This constraint is particularly important for gases to be treated having a CO₂ content that is already less than or equal to the desired specification. A maximum H₂S absorption capacity is then sought with a maximum H₂S absorption selectivity towards CO₂. This selectivity allows recovering an acid gas at the regenerator outlet having the highest H₂S concentration possible, which limits the size of the sulfur chain units downstream from the treatment and guarantees better operation. In some cases, an H₂S enrichment unit is necessary for concentrating the acid gas in H₂S. The most selective amine will also be sought in this case. Tertiary amines such as methyldiethanolamine or hindered amines exhibiting slow reaction kinetics with CO₂ are commonly used, but they have limited selectivities at high H₂S feed ratios.

Whether seeking maximum CO₂ capture kinetics in a total deacidizing application or minimum CO₂ capture kinetics in a selective application, it is always desirable to use a solvent having the highest cyclic capacity possible. Indeed, the higher the cyclic capacity of the solvent, the more limited the solvent flow rates required for deacidizing the gas to be treated.

One essential aspect of treating industrial fumes or gas with solvents is the absorption stage. Dimensioning of the absorption column is essential to provide proper operation of the unit. If, as mentioned above, the CO₂ capture kinetics are a determinant criterion for the column height, the cyclic capacity of the solvent is a determinant criterion for the column diameter. In fact, the higher the cyclic capacity of the solvent, the lower the solvent flow rate required for treating the acid gas. Thus, the lower the solvent flow rate circulating in the column, the smaller the absorption column diameter, without any column obstruction phenomenon. In an application where the absorption column is under pressure, such as natural gas or syngas treatment, the diameter of the column has a huge impact on the steel mass making up the absorption column, and therefore on its cost.

In the case of deacidizing at atmospheric pressure, the cost related to the construction of the absorption column is lower, but it can generally not be disregarded. If we take the example of post-combustion CO₂ capture is considered where the CO₂ concentration is very low, it is observed that the flow rate of gas to be treated is often a more dimensioning criterion than the solvent capacity. However, the solvent capacity and therefore the flow to be circulated in the plant will have a great impact on various investment and operating costs of the plant. The costs related to the pumps and the electric power required for operating them can be mentioned by way of example.

Another essential aspect of the operations for treating industrial fumes or gas with a solvent is the regeneration of the separation agent. Regeneration through expansion and/or distillation and/or entrainment by a vaporized gas referred to as “stripping gas” is generally provided depending on the absorption type (physical and/or chemical).

One of the limitations of the solvents commonly used today is the energy consumption necessary for solvent regeneration that is too high. This is particularly true in cases where the acid gas partial pressure is low. For example, for a 30 wt. % monoethanolamine aqueous solution used for post-combustion CO₂ capture in a thermal power plant fume, where the CO₂ partial pressure is of the order of 0.12 bar, the regeneration energy represents approximately 3.7 GJ per ton of CO₂ captured. Such an energy consumption represents a considerable operating cost for the CO₂ capture process.

It is well known that the energy required for regeneration by distillation of a chemical solvent can be divided into three different items: the energy required for heating the solvent between the top and the bottom of the regenerator, the energy required for lowering the acid gas partial pressure in the regenerator by vaporization of a stripping gas, and the energy required for breaking the chemical bond between the amine and the CO₂.

These first two items are inversely proportional to the absorbent solution flows to be circulated in the plant to achieve a given specification. In order to decrease the energy consumption linked with the regeneration of the solvent, it is therefore again preferable to maximize the cyclic capacity of the solvent.

The last item relates to the energy to be supplied for breaking the bond created between the amine used and the CO₂. In order to decrease the energy consumption linked with the regeneration of the solvent, it is thus preferable to minimize the bond enthalpy ΔH. However, it is not obvious to find a solvent having both a high cyclic capacity and a low reaction enthalpy. The best solvent regarding energy is therefore a solvent allowing the best compromise between a high cyclic capacity Δα and a low bond enthalpy ΔH.

It is difficult to find compounds or a family of compounds allowing the various deacidizing processes to operate at low operating costs (including the regeneration energy and the solvent circulation costs) and investments (including the height and the diameter of the absorption column), whether in a total deacidizing application or in a selective H₂S removal application.

The applicant has found that the compounds meeting the definition of the triamines below are of great interest in all the gaseous effluent treatment processes intended for acid compounds removal.

### SUMMARY OF THE INVENTION

The present invention overcomes one or more of the drawbacks of the prior art by providing a method for removing acid compounds such as CO₂, H₂S, COS, CS₂, SO₂ and mercaptans from a gas using a specific amine whose absorbent properties are greater than those of the reference amines used in post-combustion CO₂ capture applications and natural gas treatment applications, that is monoethanolamine (MEA) and methyldiethanolamine (MDEA) respectively.

In general terms, the present invention describes a method of removing the acid compounds contained in a gaseous effluent, wherein an acid compound absorption is carried out by contacting the effluent with an absorbent solution comprising:

a—water;

b—at least one triamine comprising two tertiary amine functions and one secondary amine function, the triamine having the general formula (I) as follows:

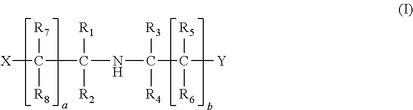

wherein:

each radical R1, R2, R3, R4, R5, R6, R7 and R8 is independently selected from among:
a hydrogen atom,
an alkyl or alkylene hydrocarbon radical comprising 1 to 6 carbon atoms,

each integer a and b is selected independently between 1 and 5, and

each radical X and Y is selected independently from among structures A and B, structure A being a radical of general formula:

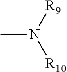

wherein each radical R9 and R10 is independently selected from among an alkyl or alkylene hydrocarbon radical comprising 1 to 6 carbon atoms,
structure B being a radical of general formula:

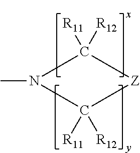

wherein each radical R11 and R12 is independently selected from among a hydrogen atom or an alkyl or alkylene hydrocarbon radical comprising 1 to 6 carbon atoms, and wherein Z is an ether function or Z is a covalent bond, and wherein x and y are integers selected independently between 1 and 3;
the selection of X, Y and radicals R1, R2, R3 and R4 meeting one of the following rules:
   rule No. 1: X and Y each meet the definition of B; or
   rule No. 2: X meets the definition of A and Y meets the definition of B; or
   rule No. 3: X meets the definition of B and Y meets the definition of A; or
   rule No. 4: X and Y each meet the definition of A and at least one of the four
   radicals R1, R2, R3 and R4 is an alkyl or alkylene hydrocarbon radical comprising between 1 and 6 carbon atoms.

According to the invention, preferably:
each radical R1, R2, R3, R4, R5, R6, R7 and R8 can be independently selected from among a hydrogen atom, a methyl radical or an ethyl radical;
each number a and b can be selected independently equal to 1 or 2;
each radical R9 and R10 can be independently selected from among a methyl radical or an ethyl radical;
R11 and R12 can be hydrogen atoms; and
the selection of X, Y and radicals R1, R2, R3 and R4 can meet one of rules No. 2, 3 or 4.

The triamine can be selected from the group consisting of N,N-dimethyl-N′-[1(dimethylamino)-2-propyl]-1,2-ethanediamine, N,N-diethyl-N′-[1(dimethylamino)-2-propyl]-1,2-ethanediamine, 3(N.N-dimethylaminopropyl)imino-2-(N.N-dimethyl-propyl-amine), N,N-diethyl-N′-[1(dimethylamino)-2-propyl]-1,3-propanediamine, [N,N-dimethyl-N′-(3-N-morpholinopropyl]-1,2-propanediamine, N,N-diethyl-N′-[1(dimethyl-aminoethyl]-1,4-pentane diamine, N,N-diethyl-N′-[2-ethyl-N″-morpholino]-1,3-propane-diamine, N,N-dimethyl-N′-[2-ethyl-N″-morpholino]-1,3-propanediamine, N,N-diethyl-N′-[2-ethyl-N″-pyrolidino]-1,3-propanediamine and N,N-diethyl-N′-[2-ethyl-N″-piperidinyl]-1,3-propanediamine.

Preferably, the secondary amine function can be bonded to at least one quaternary carbon or two tertiary carbons. In this case, the triamine can be selected from the group consisting of N,N-diethyl-N′-[1(dimethylamino)-2-propyl]-1,4-pentanediamine, N,N-diethyl-N′-[1(dimethylamino)-3-butyl]-1,4-pentanediamine, N,N-diethyl-N′-[1(diethyl-amino)-3-butyl]-1,4-pentanediamine and N,N-diethyl-N′-[1(diethyl-amino)-2-methyl-3-pentyl]-1,4-pentanediamine.

According to the invention, the absorbent solution can comprise between 10 and 60 wt. % triamine and between 10 and 90 wt. % water. The absorbent solution can also comprise a non-zero proportion, below 20 wt. %, of an activating compound, said compound comprising a primary or secondary amine function. The activating compound can be selected from the group consisting of:

MonoEthanolAmine,

N-butylethanolamine

Aminoethylethanolamine,

Diglycolamine,

Piperazine,

N-(2-hydroxyethyl)Piperazine,

N-(2-aminoethyl)Piperazine,

Morpholine,

3-(metylamino)propylamine.

The absorbent solution can also comprise a physical solvent selected from among methanol and sulfolane.

The acid compound absorption stage can be carried out at a pressure ranging between 1 bar and 120 bars, and at a temperature ranging between 20° C. and 100° C.

In the method according to the invention, a regeneration of the absorbent solution laden with acid compounds, wherein at least one of the following operations is performed: heating, expansion, distillation, can be carried out. The regeneration stage can be carried out at a pressure ranging between 1 bar and 10 bars, and at a temperature ranging between 100° C. and 180° C.

The gaseous effluent can be selected from among natural gas, syngas, combustion fumes, refinery gas, Claus tail gases, biomass fermentation gases, cement plant gases and incinerator fumes.

The method according to the invention can be implemented for selective H₂S removal from a gaseous effluent containing H₂S and CO₂.

In fact, it has been discovered that the compounds meeting the definition of the triamines according to the invention allow obtaining higher cyclic capacities than the reference amines, whether in applications where the acid gas partial pressure is low or in applications where the acid gas partial pressure is high. This performance is certainly increased by the greater density of amine sites in relation to the molar mass of the molecules, and also by the fact that there is, on the same molecule, one secondary amine function and two tertiary amine functions that cannot form carbamates around the secondary amine function. Besides, by varying the steric hindrance of the secondary amine function, it is possible to obtain high-performance amines in total deacidizing applications as well as in applications where selective H₂S removal is sought.

The invention relates to a method of absorbing the acid compounds of a gaseous effluent by contacting the gaseous effluent with a liquid absorbent solution comprising:

water;

at least one triamine wherein the 3 amine functions are not connected to each other by rings and whose amine functions in a and w positions are always tertiary, and the amine function in central position is always secondary, more or less sterically hindered, and who have the general formula (I) as follows:

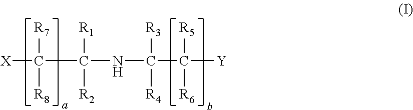

Each radical R1, R2, R3 and R4 is independently selected from among:
a hydrogen atom or
an alkyl or alkylene hydrocarbon radical comprising 1 to 6 carbon atoms,
preferably an alkyl hydrocarbon radical comprising 1 to 3 carbon atoms and preferably 1 to 2 carbon atoms.

Each radical R5, R6, R7 and R8 is independently selected from among:
a hydrogen atom or
an alkyl or alkylene hydrocarbon radical comprising 1 to 6 carbon atoms,
preferably an alkyl hydrocarbon radical comprising 1 to 3 carbon atoms and preferably 1 to 2 carbon atoms.

R5, R6, R7 and R8 are preferably hydrogen atoms.

Integers a and b are independently selected between 1 and 5, preferably each number a and b is independently equal to 1 or 2.

Each radical X and Y is independently selected from among structures A and B defined hereafter and according to the rules described below.

A is a radical of general formula:

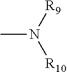

wherein R9 and R10 is independently selected from among an alkyl or alkylene hydrocarbon radical comprising 1 to 6 carbon atoms, preferably an alkyl hydrocarbon radical comprising 1 to 3 carbon atoms and preferably 1 or 2 carbon atoms. Preferably, radical A is a dimethylamine or diethylamine radical.

B is a radical of general formula:

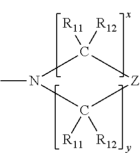

wherein R11 and R12 is independently selected from among a hydrogen atom or an alkyl or alkylene hydrocarbon radical comprising 1 to 6 carbon atoms, preferably an alkyl hydrocarbon radical comprising 1 to 3 carbon atoms, preferably 1 or 2 carbon atoms; and
wherein R11 and R12 preferably are hydrogen atoms;
n Z is an ether function, that is. a —O— motif, or Z is a covalent bond; and
integers x and y are independently selected between 1 and 3.

When Z is an ether function, i.e. a —O— motif, x and y are preferably each equal to 2. When Z is a covalent bond, sum (x+y) is preferably equal to 4 or 5.

Preferably, radical B is a piperidine, morpholine or pyrrolidine ring.

According to the invention, X, Y and radicals R1, R2, R3 and R4 are selected in accordance with one of the following rules:
rule No. 1: X and Y each meet the definition of B; or
rule No. 2: X meets the definition of A and Y meets the definition of B; or
rule No. 3: X meets the definition of B and Y meets the definition of A; or
rule No. 4: X and Y each meet the definition of A and, in this case, at least one of the four radicals R1, R2, R3 and R4 is imperatively different from a hydrogen atom, in which the steric hindrance of the secondary amine function is imperatively strengthened. In rule No.4, preferably one or two of the four radicals R1, R2, R3 and R4 are imperatively different from a hydrogen atom, in which, preferably one or two of the four radicals R1, R2, R3 and R4 are alkyl hydrocarbon radicals as described above.

Preferably, according to the invention, X and Y, and radicals R1, R2, R3 and R4 are selected in accordance with one of rules No. 2, 3 and 4.

In particular, the invention relates to a method for selective H₂S removal from a gas containing H₂S and CO₂. For this application, the triamine according to the invention is so selected that the secondary amine function is severely hindered, that is the secondary amine function is connected to at least one quaternary carbon or to two tertiary carbons. In other words, the severely hindered secondary amine function is connected to a quaternary carbon and a secondary carbon, a quaternary carbon and a tertiary carbon, two tertiary carbons or two quaternary carbons.

Examples of compounds of general formula (I) can be given:
in cases where the tertiary triamine according to the invention has a quaternary carbon at alpha of the —NH— function, for example the compound of general formula (I) is such that radicals R1 and R2 are both hydrogens and radicals R3 and R4 are both methyls,
in cases where the tertiary triamine according to the invention has two tertiary carbons at alpha of the —NH— function, for example the compound of general formula (I) is such that radicals R1 and R3 are both hydrogens and radicals R2 and R4 are both methyls.

### BRIEF DESCRIPTION OF THE DRAWING

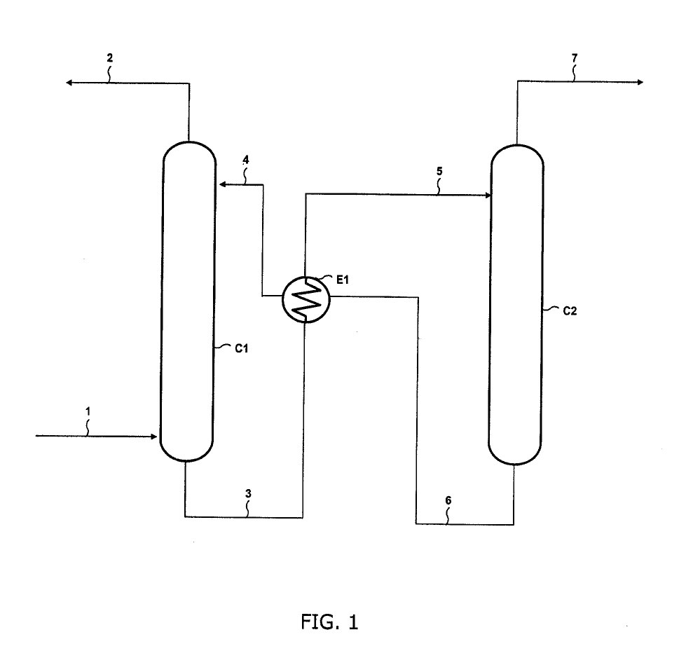

Other features and advantages of the invention will be clear from reading the description hereafter, with reference to FIG. 1 that shows a flow sheet of an acid gas effluent treating method.

### DETAILED DESCRIPTION OF THE INVENTION

The compounds of general formulas (I) are of interest in all the acid gas (natural gas, combustion fumes, syngas, etc.) treatment processes in an absorbent solution aqueous composition.

The present invention removes acid compounds from a gaseous effluent using an absorbent compound in aqueous solution. The triamines according to the invention have a higher absorption capacity with acid compounds (notably CO₂, H₂S, COS, SO₂, CS₂, mercaptans) than the conventionally used monoethanolamine (MEA) and methyldiethanolamine (MDEA). Indeed, the compounds of general formulas (I) have the specific feature of having very high feed ratios α=n_{acid gas}/nₐₘᵢₙₑ (α designating the ratio between the number of moles of acid compounds n_{acid gas} absorbed by a portion of absorbent solution and the number of moles of amine nₐₘᵢₙₑ contained in the absorbent solution portion) whatever the application sought, in comparison to the conventionally used MEA and MDEA. Using an aqueous absorbent solution according to the invention saves on the investment costs and the operating costs of a deacidizing plant (gas treatment and CO₂ capture). In the particular case of the triamines according to the invention for which the secondary amine function is severely hindered, the invention reduces the amount of CO₂ captured for a higher H₂S feed ratio in comparison with MDEA. This capacity and selectivity gain leads to savings on the investment costs and the operating costs of the deacidizing plant and of the downstream Claus plant that treats a H₂S-richer gas.

Nature of the Gaseous Effluents

The absorbent solutions according to the invention can be used to deacidize the following gaseous effluents: natural gas, syngas, combustion fumes, refinery gas, Claus tail gas, biomass fermentation gas, cement plant gas and incinerator fumes. These gaseous effluents contain one or more of the following acid compounds: CO₂, H₂S, mercaptans, COS, CS₂, SO₂.

Combustion fumes are produced notably by the combustion of hydrocarbons, biogas, coal in a boiler or for a combustion gas turbine, for example in order to produce electricity. These fumes are at a temperature ranging between 20° C. and 60° C., at a pressure ranging between 1 and 5 bars, and they can comprise between 50 and 80% nitrogen, between 5 and 40% carbon dioxide, between 1 and 20% oxygen, and some impurities such as SOx and NOx if they have not been removed downstream of the deacidizing process.

Syngas contains carbon monoxide CO, hydrogen H₂ (generally with a H₂/CO ratio of 2), water vapour (generally at saturation at the wash temperature) and carbon dioxide CO₂ (of the order of 10%). The pressure generally ranges between 20 and 30 bars, but it can reach up to 70 bars. It also comprises sulfur-containing (H₂S, COS, etc.), nitrogen-containing (NH₃, HCN) and halogenated impurities.

Natural gas predominantly is gaseous hydrocarbons, but it can contain some of the following acid compounds: CO₂, H₂S, mercaptans, COS, CS₂. The proportion of these acid compounds is very variable and it can reach up to 40% for CO₂ and H₂S. The temperature of the natural gas can range between 20° C. and 100° C. The pressure of the natural gas to be treated can range between 10 and 120 bars.

Synthesis Paths for Compounds (I)

The triamines according to the invention can be synthesized according to various reaction paths. The following paths can be mentioned by way of non-exhaustive example:

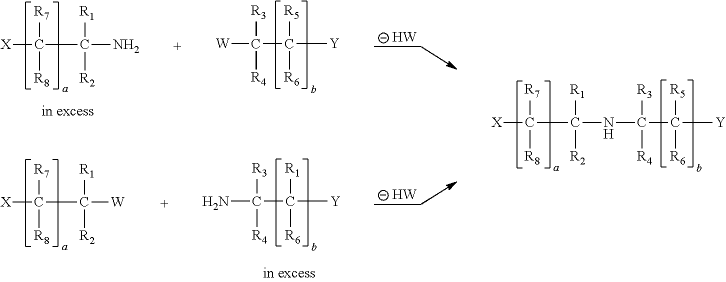

wherein W is a releasable group in the sense of organic chemistry. It is generally selected from a halogen atom, notably a chlorine, bromine or iodine atom. W can also be a tosylate or mesylate radical, well known as releasable groups. In some cases, the nitro groups can satisfy the reaction.

These are conventional condensation reactions. Obtaining the secondary amine function is conditioned by the excess primary amine, that is the ratio of the number of moles of primary amine to the number of moles of the synthon carrying the releasable group W. The ideal ratio for selectively obtaining a secondary amine and avoiding a second condensation reaction that would lead to a tertiary amine function has to be determined specifically for each reaction. Generally, this ratio ranges between 2 and 10, most often between 3 and 7.

It can be noted that the precursors of these reactions always carry a tertiary amine function that is specified with the definitions of X and Y. In some cases, these functions can be present in form of halohydrates, chlorhydrates for example.

Or for example:

Here again a condensation reaction that leads to molecules meeting the general formula and wherein groups X and Y are identical.

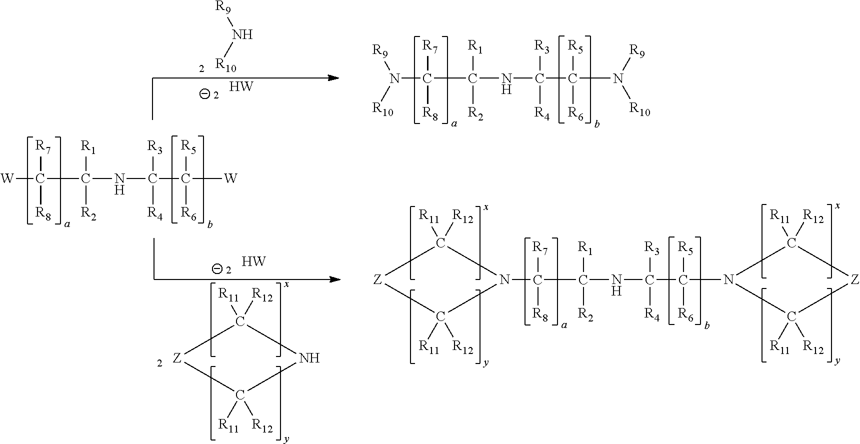

Or for example the following paths that can lead to molecules meeting the general formula of the invention. These paths are based on the addition of a primary amine to the unsaturation of an acrylamide derivative, followed by the hydrogenation of the carbonyl function that converts the amide function to amine.

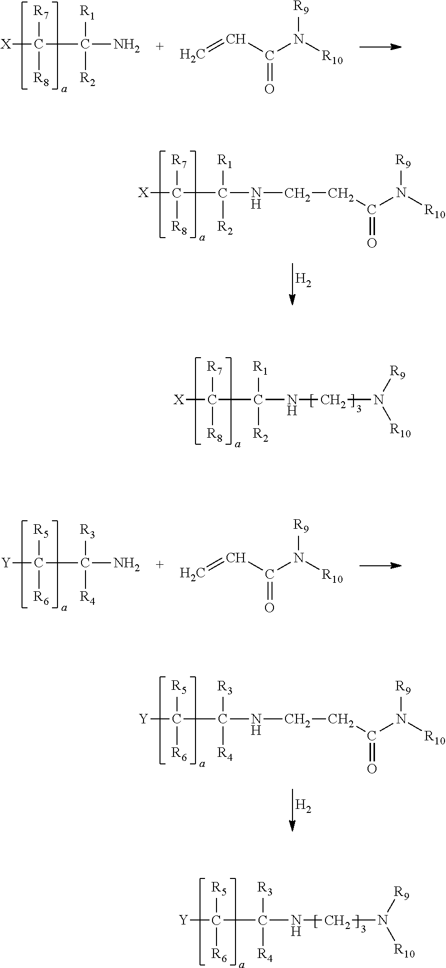

Triamines according to the invention can also be obtained first by reacting a synthon 1 carrying a primary amine function with a synthon 2 carrying an aldehyde or ketone function in order to obtain an imine, then by conducting a hydrogenation stage leading to a secondary amine. This synthesis path illustrated hereafter affords the advantage of generating no by-products such as salts in case of condensation of an amine on a halogenide.

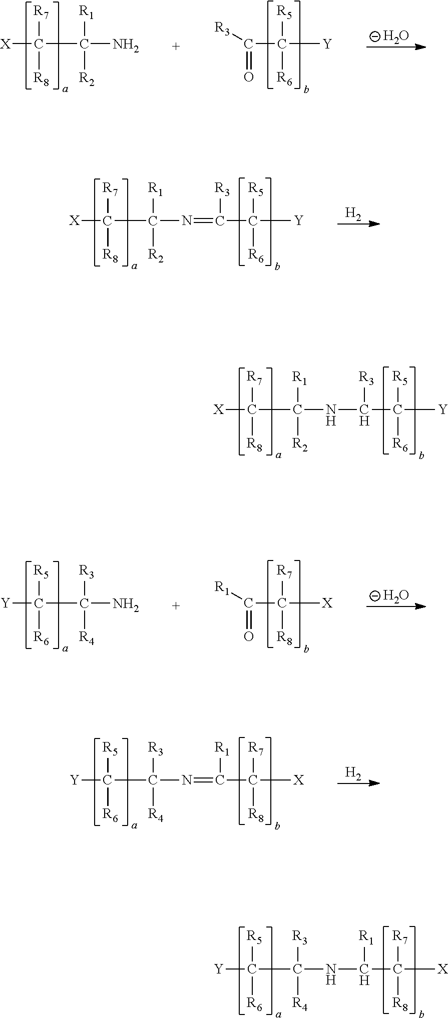

It can be very easy for example to obtain a synthon 2 carrying a tertiary amine and a ketone function by reacting attractive reactants in terms of cost and availability, such as acetone, formaldehyde and a secondary amine according to the well-known Mannich reaction that can be illustrated as follows:

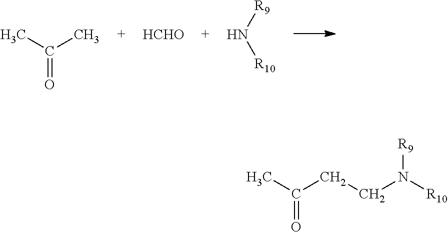

Examples of Triamines (I)

Among the molecules of the invention, the following non-exhaustive list of molecules can be mentioned. The molecules of list a) having a low or moderate hindrance of the —NH— function have to be distinguished from the molecules of list b) having a severe hindrance of the —NH— function. The molecules of list b) are particularly suitable for selective H₂S removal from a gas containing H₂S and CO₂.

a) Molecules with Low or Moderate Hindrance

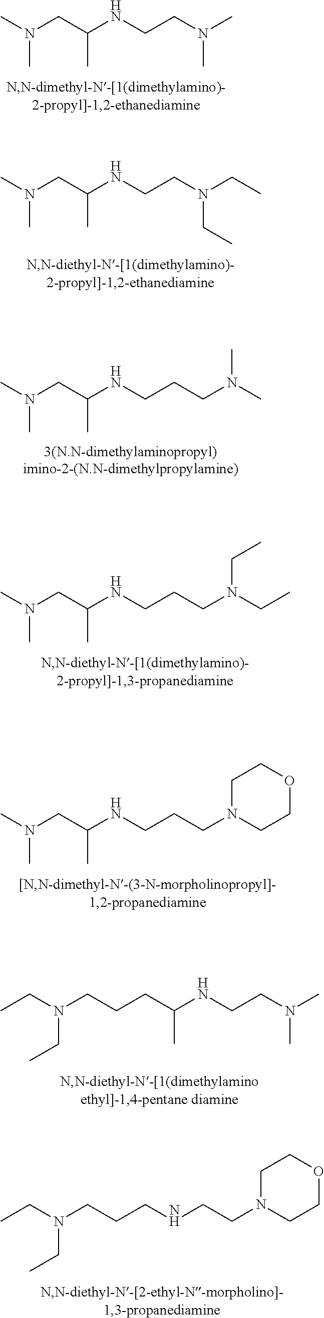

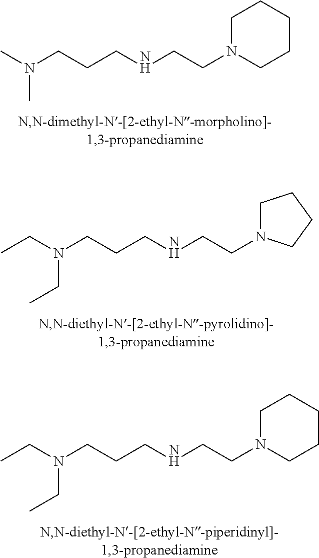 [SMILES: CN(C)CCCNCCN1CCCCC1 ; CCN(CC)CCCNCCN1CCCC1 ; CCN(CC)CCCNCCN1CCCCC1]

b) Molecules with Severe Hindrance

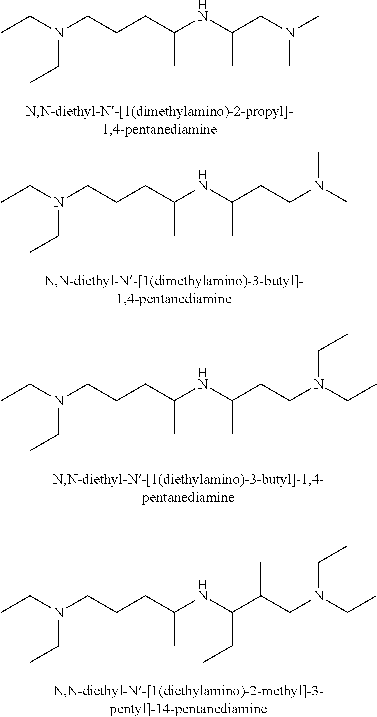

Composition of the Absorbent Aqueous Solution

The triamines according to the invention can be in variable concentrations, ranging for example between 10 and 90 wt. %, preferably between 20 and 60 wt. %, more preferably between 30 and 50 wt. % in the aqueous solution.

The absorbent solution can contain between 10 and 90 wt. % water, preferably between 50 and 70 wt. % water.

In an embodiment, the compounds of general formula (I) can be formulated with another amine containing at least one primary or secondary amine function (activator), up to a concentration of 20 wt. %, preferably below 15 wt. % and more preferably below 10 wt. %. This type of formulation is particularly interesting in the case of CO₂ capture in industrial fumes, or treatment of natural gas containing CO₂ and/or COS above the desired specification. Indeed, for this type of applications, one wants to increase the CO₂ and/or COS capture kinetics in order to reduce the size of the equipments.

A non-exhaustive list of compounds that can be used as activators is given below:

MonoEthanolAmine,

N-butylethanolamine

Aminoethylethanolamine,

Diglycolamine,

Piperazine,

N-(2-hydroxyethyl)Piperazine,

N-(2-aminoethyl)Piperazine,

Morpholine,

3-(metylamino)propylamine.

The absorbent solution can contain a physical solvent, methanol or sulfolane for example.

Method of removing acid compounds from a gaseous effluent

Using an absorbent solution for deacidizing a gaseous effluent is achieved schematically by carrying out an absorption stage, followed by a regeneration stage, as shown in FIG. 1 for example. The absorption stage contacts the gaseous effluent containing the acid compounds to be removed with the absorbent solution in an absorption column C1. The gaseous effluent to be treated 1 and the absorbent solution 4 are fed into column C1. Upon contacting, the organic compounds provided with an amine function of absorbent solution 4 react with the acid compounds contained in effluent 1 to obtain a gaseous effluent depleted in acid compounds 2 that leaves the top of column C1 and an absorbent solution enriched in acid compounds 3 that leaves the bottom of column C1. The absorbent solution enriched in acid compounds 3 is sent to an exchanger El where it is heated by stream 6 coming from regeneration column C2. The laden absorbent solution 5 heated at the outlet of exchanger E1 is fed into distillation column (or regeneration column) C2 where regeneration of the absorbent solution laden with acid compounds takes place. Optionally, prior to being fed into column C2, absorbent solution 3 or 5 laden with acid compounds can be expanded. The regeneration stage can thus be heating, optionally in expanding or in distilling the absorbent solution enriched in acid compounds in order to release the acid compounds that leave the top of column C2 in gas form 7. The regenerated absorbent solution, that is depleted in acid compounds 6, leaves the bottom of column C2 and flows into exchanger E1 where it yields heat to stream 3 as described above. The regenerated and cooled absorbent solution 4 is then recycled to absorption column C1.

The acid compound absorption stage can be carried out at a pressure ranging between 1 and 120 bars, preferably between 20 and 100 bars for natural gas treatment, preferably between 1 and 3 bars for industrial fumes treatment, and at a temperature ranging between 20° C. and 100° C., preferably between 30° C. and 90° C., or even between 30° C. and 60° C.

The regeneration of the method according to the invention can be carried out by thermal regeneration, optionally complemented by one or more expansion stages.

Regeneration can be carried out at a pressure ranging between 1 and 5 bars, or even up to 10 bars, and at a temperature ranging between 100° C. and 180° C., preferably between 130° C. and 170° C. Preferably, the regeneration temperature ranges between 155° C. and 180° C. in cases where reinjection of the acid gases is desired. The regeneration temperature preferably ranges between 115° C. and 130° C. in cases where the acid gas is sent to the atmosphere or to a downstream treating process such as a Claus process or a tail gas treating process.

### EXAMPLES

The synthesis operating procedure is given for some molecules belonging to the family of compounds (I).

The absorbent solutions used in these examples are aqueous solutions comprising 30 wt. % triamines according to the invention.

The performances (i.e. CO₂ capture capacity) are compared, notably with those of a 30 wt. % MonoEthanolAmine aqueous solution that constitutes the reference absorbent solution for a post-combustion fumes capture application and those of a 40 wt. % MethylDiethanolAmine aqueous solution that constitutes the reference absorbent solution for a natural gas treatment application.

For selective H₂S removal, the performances (i.e. feed ratio and selectivity) of an aqueous solution of a compound (I) whose amine function is severely hindered are compared with those of a MethylDiethanolAmine aqueous solution that constitutes the reference solvent in a selective deacidizing application for natural gas treatment.

### Example 1

### Operating Procedure for the Synthesis of Amines of General Formula (I)

For information, the following examples illustrate the synthesis of some molecules of the invention, it being understood that all the synthesis possibilities for these molecules, regarding the synthesis paths considered as well as the possible operating modes, are not described here.

### N,N-diethyl-N′-[2-ethyl-N″-morpholino]-1,3-propanediamine

537 g (4.13 moles) 3-diethylaminopropylamine and 153.9 g (0.83 mole) 4-(2-chloroethyl)morpholine in chlorhydrate form are fed into a drum. The medium is brought to a temperature of 80° C. for 5 hours, then, after returning to ambient temperature, the medium is neutralized with 69.5 g soda pellets for 1 hour at 80° C. After filtering, the solid is washed with ether, then the ethereal fraction is added to the product and distillation of the medium is performed. 153.5 g of a fraction distilling around 127° C. in 1.5 mm Hg, whose purity determined by gas chromatography is 97.7% and whose NMR spectrum is in accordance with the desired theoretical structure, are recovered.

### N,N-diethyl-N′-[2-ethyl-N″-pyrolidino]-1,3-propanediamine

419.8 g (3.23 moles) 3-diethylaminopropylamine and 109.8 g (0.65 mole) 1-(2-chloroethyl)pyrrolidine in chlorhydrate form are fed into a drum. The medium is brought to a temperature of 80° C. for 5 hours, then, after returning to ambient temperature, the medium is neutralized in the presence of 54.0 g soda and 40 ml water. After filtering, the solid is washed with ether, then the ethereal fraction is added to the product and distillation of the medium is performed. 113.0 g of a fraction distilling between 100° C. and 103° C. under 0.8 mbar, whose purity determined by gas chromatography is 97.6% and whose NMR spectrum is in accordance with the desired theoretical structure, are recovered.

### N,N-diethyl-N′-[2-ethyl-N″-piperidinyl]-1,3-propanediamine

310 g (2.38 moles) 3-diethylaminopropylamine and 87.8 g (0.48 mole) 2,2-chloroethylpiperidine in chlorhydrate form are fed into a drum. The medium is brought to a temperature of 80° C. for 5 hours, then, after returning to ambient temperature, the medium is neutralized with 40.1 g soda pellets for 1 hour at 80° C. After filtering, the solid is washed with n-heptane, then the wash fraction is added to the product and distillation of the medium is performed. 89.9 g of a fraction distilling between 112° C. and 114° C. in 1 mm Hg, whose purity determined by gas chromatography is 96.7% and whose NMR spectrum is in accordance with the desired theoretical structure, are recovered.

### N,N-dimethyl-N′-[1(dimethylamino)-2-propyl]-1,2-ethanediamine

338.9 g (3.85 moles) N,N-dimethylethylenediamine and 121.7 g (0.77 mole) 1-dimethylamino-2-chloropropane in chlorhydrate form are fed into a drum. The medium is brought to a temperature of 80° C. for 5 hours. After evaporation of the excess amine, the medium is neutralized, at ambient temperature, with 64.7 g soda in the presence of 80 ml ethanol and 25 ml water. After filtering, distillation of the medium is performed. 89 g of a fraction distilling between 38° C. and 41° C. under 0.5 mm Hg, whose NMR spectrum is in accordance with the desired theoretical structure, are recovered.

### N,N-diethyl-N′-[1(dimethylamino)-2-propyl]-1,2-ethanediamine

104.0 g (0.89 mole) N,N-diethylethylenediamine and 28.3 g (0.18 mole) 1-dimethylamino-2-chloropropane in chlorhydrate form are fed into a drum. The medium is brought to a temperature of 80° C. for 5 hours, then, after returning to ambient temperature, the medium is neutralized in the presence of 15.0 g soda pellets for 1 hour at 80° C. After filtering, the solid is washed with ethanol, then the wash fraction is added to the product and distillation of the medium is performed. 31.6 g of a fraction distilling between 50° C. and 55° C. under 0.9 mm Hg, whose NMR spectrum is in accordance with the desired theoretical structure, are recovered.

### N,N-diethyl-N′-[1(dimethylamino)-2-propyl]-1,3-propanediamine

403.0 g (3.10 moles) 3-diethylaminopropylamine and 98 g (0.62 mole) 1-dimethylamino-2-chloropropane in chlorhydrate form are fed into a drum. The medium is brought to a temperature of 80° C. for 5 hours, then, after returning to ambient temperature, the medium is neutralized in the presence of 53.2 g soda and 40 ml water. After filtering, the solid is washed with n-heptane, then the wash fraction is added to the product and distillation of the medium is performed. 83.2 g of a fraction distilling between 78° C. and 80° C. under 1 mm Hg, whose NMR spectrum is in accordance with the desired theoretical structure, are recovered.

### N,N-diethyl-N′-[1(dimethylaminoethyl]-1,4-pentane diamine

438.9 g (2.78 moles) 2-amino-5-diethylaminopentane and 100.0 g (0.69 mole) dimethylaminoethyl chloride in chlorhydrate form are fed into a drum. The medium is brought to a temperature of 80° C. for 6 hours, then, after returning to ambient temperature, the medium is neutralized with 58.3 g soda in the presence of 50 ml water. After filtering, the solid is washed with ether, then the wash fraction is added to the product and distillation of the medium is performed. After removal of the excess amine and of the solvent, 74.7 g of a fraction distilling between 86° C. and 87° C. under 0.3 mm Hg, whose NMR spectrum is in accordance with the desired theoretical structure, are recovered.

### Example 2

### Capture Capacity of Amines of General Formula (I) Containing a Tertiary Nitrogen Taken in a Ring

An absorption test is carried out on aqueous amine solutions in a perfectly stirred closed reactor whose temperature is controlled by a regulation system. For each solution, absorption is conducted in a 50-cm³ liquid volume by injections of pure CO₂ from a reserve. The solvent solution is first evacuated prior to any CO₂ injection. The pressure of the gas phase in the reactor is then monitored as a function of time after the CO₂ injections. A global material balance on the gas phase allows to measure the solvent feed ratio α=nb moles of acid gas/nb moles of amine.

By way of example, the feed ratios (α=nb moles of acid gas/nb moles of amine) obtained at 40° C. for different CO₂ partial pressures can be compared between N,N-diethyl-N′-[2-ethyl-N″-morpholino]-1,3-propanediamine, N,N-diethyl-N′-[2-ethyl-N″-pyrolidino]-1,3-propanediamine and N,N-diethyl-N′-[2-ethyl-N″-piperidinyl]-1,3-propane-diamine absorbent solutions according to the invention and a 30 wt. % MonoEthanolAmine absorbent solution for a post-combustion CO₂ capture application, and a 40 wt. % MethylDiethanolAmine absorbent solution for a natural gas decarbonation application for meeting the liquefied natural gas specifications.

Switching from a quantity for the feed ratio obtained in the laboratory to a quantity characteristic of the method requires some calculations that are explained below for the two applications that are sought.

In the case of a post-combustion CO₂ capture application, the CO₂ partial pressures in the effluent to be treated are typically 0.1 bar with a temperature of 40° C., and a 90% acid gas abatement is sought. One thus considers the feed ratio of the absorbent solution corresponding to a CO₂ partial pressure of 0.1 bar at equilibrium.

In the case of a natural gas decarbonation application for an application for obtaining a liquefied natural gas (LNG), the CO₂ partial pressures in the gas to be treated are, for example, 0.3 bar and 1 bar with a temperature of 40° C. A 50 ppm specification is desired here, which at first approximation corresponds to a completely regenerated solvent (α_{50 ppm}˜0). The cyclic capacity Δα_{LNG} expressed in moles of CO₂ per kg of absorbent solution is then calculated, considering that the solvent reaches its maximum thermodynamic capacity at the absorption column bottom α_{PPCO2=0.3 bar} and α_{PPCO2=1 bar} for partial pressures of 0.3 and 1 bar respectively.

Δα_{LNG}^{0.3 bar}=(α_{PPCO2=0.3 bar}−α_{50 ppm})·[A]·10/M≈(α_{PPCO2=0.3 bar})·[A]·10/M

Δα_{LNG}^{1 bar}=(α_{PPCO2=1 bar}−α_{50 ppm})·[A]·10/M≈(α_{PPCO2=1 bar})·[A]·10/M

where [A] is the amine concentration expressed in wt. % and M the molar mass of the amine in g/mol.

Case relative to post-combustion CO₂ capture

| | Concen- | T | | PPCO2 = |
|---|---|---|---|---|
| Generic name | tration | (° C.) | | 0.1 bar |
| N,N-diethyl-N′-[2-ethyl- | 30 wt. % | 40 | Feed ratio = | 1.04 |
| N″-morpholino]-1,3- | | | nCO2/ | |
| propanediamine | | | namine | |
| N,N-diethyl-N′-[2-ethyl- | 30 wt. % | 40 | | 1.77 |
| N″-pyrolidino]-1,3- | | | | |
| propanediamine | | | | |
| N,N-diethyl-N′-[2-ethyl- | 30 wt. % | 40 | | 1.78 |
| N″-piperidinyl]-1,3- | | | | |
| propanediamine | | | | |
| MonoEthanolAmine | 30 wt. % | 40 | | 0.52 |

Case relative to natural gas decarbonation for a LNG specification

| | | | | | □□^{0.3 bar} | | □□^{1 bar} |
|---|---|---|---|---|---|---|---|
| | | | | | (mol | | (mol |
| | | T | | PPCO₂ = | CO₂/kg | PPCO₂ = | CO₂/kg |
| Generic name | Concentration | (° C.) | | 0.3 bar | Solvent) | 1 bar | Solvent) |
| N,N-diethyl-N′-[2-ethyl-N″- | 30 wt. % | 40 | Feed | 1.90 | 2.50 | 1.98 | 2.61 |
| pyrolidino]-1,3- | | | ratio = | | | | |
| propanediamine | | | nCO2/namine | | | | |
| N,N-diethyl-N′-[2-ethyl-N″- | 30 wt. % | 40 | | 1.92 | 2.39 | 2.01 | 2.50 |
| piperidinyl]-1,3- | | | | | | | |
| propanediamine | | | | | | | |
| MethylDiEthanolAmine | 40 wt. % | 40 | | 0.50 | 1.68 | 0.70 | 2.35 |

This example shows the higher feed ratios that can be obtained by an absorbent solution according to the invention, comprising 30 wt. % molecules of general formula (I), at low as well as high acid gas partial pressures.

Furthermore, for a natural gas decarbonation application where the CO₂ partial pressure in the effluent to be treated ranges between 0.3 and 1 bar, this example illustrates the higher cyclic capacity in moles CO₂ per kg of absorbent solution obtained using an absorbent solution according to the invention, comprising 30 wt. % molecules of general formula (I) allowing to reach a 50 ppm CO₂ specification in the gas treated.

### Example 3

### Capture Capacity of Amines of General Formula (I) Whose Secondary Nitrogen is Hindered in α

The measurements and calculations carried out for Example 2 are repeated.

By way of example, the feed ratios (α=n acid gas/n amine) obtained at 40° C. for different CO₂ partial pressures can be compared between N,N-dimethyl-N′-[1(dimethylamino)-2-propyl]-1,2-ethanediamine, N,N-diethyl-N′-[1(dimethylamino)-2-propyl]-1,2-ethanediamine, N,N-diethyl-N′-[1(dimethylamino)-2-propyl]-1,3-propane-diamine, N,N-diethyl-N′-[1(dimethylaminoethyl]-1,4-pentane diamine absorbent solutions according to the invention and a 30 wt. % MonoEthanolAmine absorbent solution for a post-combustion CO₂ capture application, as well as a 40 wt. % MethylDiethanolAmine absorbent solution for natural gas treatment applications, more particularly decarbonation applications for meeting the liquefied natural gas specifications.

Case relative to post-combustion CO₂ capture

| | Concen- | T | | PPCO₂ = |
|---|---|---|---|---|
| Generic name | tration | (° C.) | | 0.1 bar |
| N,N-dimethyl-N′- | 30 wt. % | 40 | Feed ratio = | 1.34 |
| [1(dimethylamino)-2- | | | nCO2/ | |
| propyl]-1,2- | | | namine | |
| ethanediamine | | | | |
| N,N-diethyl-N′- | 30 wt. % | 40 | | 1.55 |
| [1(dimethylamino)-2- | | | | |
| propyl]-1,2- | | | | |
| ethanediamine | | | | |
| N,N-diethyl-N′- | 30 wt. % | 40 | | 1.68 |
| [1(dimethylamino)-2- | | | | |
| propyl]-1,3- | | | | |
| propanediamine | | | | |
| N,N-diethyl-N′- | 30 wt. % | 40 | | 1.70 |
| [1(dimethylaminoethyl]- | | | | |
| 1,4-pentane diamine | | | | |
| MonoEthanolAmine | 30 wt. % | 40 | | 0.52 |

Case relative to natural gas decarbonation for a LNG specification

| | | | | | □□^{0.3 bar} | | □□^{1 bar} |
|---|---|---|---|---|---|---|---|
| | | | | | (mol | | (mol |
| | | T | | PPCO₂ = | CO₂/kg | PPCO₂ = | CO₂/kg |
| Generic name | Concentration | (° C.) | | 0.3 bar | Solvent) | 1 bar | Solvent) |
| N,N-dimethyl-N′- | 30 wt. % | 40 | Feed | 1.62 | 2.80 | 1.83 | 3.16 |
| [1(dimethylamino)-2- | | | ratio = | | | | |
| propyl]-1,2- | | | nCO2/namine | | | | |
| ethanediamine | | | | | | | |
| N,N-diethyl-N′- | 30 wt. % | 40 | | 1.74 | 2.59 | 1.90 | 2.83 |
| [1(dimethylamino)-2- | | | | | | | |
| propyl]-1,2- | | | | | | | |
| ethanediamine | | | | | | | |
| N,N-diethyl-N′- | 30 wt. % | 40 | | 1.86 | 2.59 | 1.98 | 2.76 |
| [1(dimethylamino)-2- | | | | | | | |
| propyl]-1,3- | | | | | | | |
| propanediamine | | | | | | | |
| N,N-diethyl-N′- | 30 wt. % | 40 | | 1.94 | 2.54 | 2.10 | 2.74 |
| [1(dimethylaminoethyl]- | | | | | | | |
| 1,4-pentane diamine | | | | | | | |
| MethylDiEthanolAmine | 40 wt. % | 40 | | 0.50 | 1.68 | 0.70 | 2.35 |

This example shows the higher feed ratios that can be obtained by means of an absorbent solution according to the invention, comprising 30 wt. % molecules of general formula (I), at low as well as high acid gas partial pressures.

Furthermore, for a natural gas decarbonation application where the CO₂ partial pressure in the effluent to be treated ranges between 0.3 and 1 bar, this example illustrates the higher cyclic capacity in moles CO₂ per kg of solvent obtained using an absorbent solution according to the invention, comprising 30 wt. % molecules of general formula (I) allowing to reach a 50 ppm CO₂ specification in the gas treated.

### Example 4

### Capacity and Selectivity of H₂S Removal from a Gaseous Effluent Containing H₂S and CO₂ by an Amine Solution of Formula (I) whose Secondary Amine Function is Severely Hindered

An absorption test is carried out at 40° C. at atmospheric pressure on aqueous amine solutions.

For each solution, absorption is conducted in a 50-cm³ liquid volume by bubbling of a gas stream consisting of a mixture of nitrogen:carbon dioxide:hydrogen sulfide in a volume proportion of 89:10:1, at a flow rate of 30 NL/h for 4 hours.

The H₂S feed ratio obtained (α=nb moles of H₂S/kg solvent) and the CO₂ absorption selectivity are measured at the end of the test.

This selectivity S is defined as follows:

$$S = ( {α}_{H 2 S} / {α}_{CO 2} ) \cdot \frac{( {CO}_{2} concentration of the gaseous mixture )}{( {H}_{2} S concentration of the gaseous mixture )} i . e . here$$

$$S = 10 ( {α}_{H 2 S} / {α}_{CO 2} ) .$$

By way of example, it is possible to compare the feed ratios and the selectivity between an N,N-diethyl-N′-[1(dimethylamino)-2-propyl]-1,4-pentanediamine absorbent solution according to the invention and a 35 wt. % Methyldiethanolamine absorbent solution.

| | | | H₂S | |
|---|---|---|---|---|
| | Concen- | T | feed ratio | Selec- |
| Compound | tration | (° C.) | (mole/kg) | tivity |
| MDEA | 35% | 40 | 0.10 | 1.37 |
| N,N-diethyl-N′- | 35% | 40 | 0.44 | 2.67 |
| [1(dimethylamino)-2-propyl]- | | | | |
| 1,4-pentanediamine | | | | |

This example illustrates the feed ratio and selectivity gains that can be reached with an absorbent solution according to the invention, comprising 35 wt. % molecules of general formula (I) with severe hindrance of the secondary amine function.

1-14. (canceled)

15. A method of removing acid compounds contained in a gaseous effluent, wherein an acid compound absorption is carried out by contacting the effluent with an absorbent solution comprising:
a—water;
b—at least one triamine comprising two tertiary amine functions and one secondary amine function, the triamine having the general formula (I) as follows: 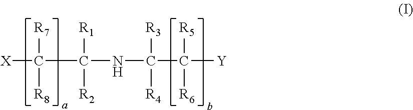
wherein:
each radical R1, R2, R3, R4, R5, R6, R7 and R8 is independently selected from among:
a hydrogen atom;
an alkyl or alkylene hydrocarbon radical comprising 1 to 6 carbon atoms;
each integer a and b is selected independently between 1 and 5;
each radical X and Y is selected independently from among structures A and B, structure A being a radical of general formula: 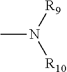
wherein each radical R9 and R10 is independently selected from among an alkyl or alkylene hydrocarbon radical comprising 1 to 6 carbon atoms;
structure B is a radical of general formula: 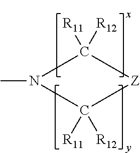
wherein each radical R11 and R12 is independently selected from among a hydrogen atom or an alkyl or alkylene hydrocarbon radical comprising 1 to 6 carbon atoms, and wherein Z is an ether function or Z is a covalent bond, and wherein x and y are integers selected independently between 1 and 3;
the selection of X, Y and radicals R1, R2, R3 and R4 meets one of the following rules:
rule No. 1: X and Y each meet the definition of B; or
rule No. 2: X meets the definition of A and Y meets the definition of B; or
rule No. 3: X meets the definition of B and Y meets the definition of A; or
rule No. 4: X and Y each meet the definition of A and at least one of the four radicals R1, R2, R3 and R4 is an alkyl or alkylene hydrocarbon radical comprising between 1 and 6 carbon atoms.

16. A method as claimed in claim 15, wherein:
each radical R1, R2, R3, R4, R5, R6, R7 and R8 is independently selected from among a hydrogen atom, a methyl radical or an ethyl radical;
each number a and b is selected independently equal to 1 or 2;
each radical R9 and R10 are independently selected from among a methyl radical or an ethyl radical;
R11 and R12 are hydrogen atoms; and
the selection of X, Y and radicals R1, R2, R3 and R4 meets one of rules No. 2, 3 or 4.

17. A method as claimed in claim 15, wherein the triamine is selected from the group consisting of N,N-dimethyl-N′-[1(dimethylamino)-2-propyl]-1,2-ethanediamine, N,N-diethyl-N′-[1(dimethylamino)-2-propyl]-1,2-ethanediamine, 3(N.N-dimethylaminopropyl)imino-2-(N.N-dimethyl-propyl-amine), N,N-diethyl-N′-[1(dimethylamino)-2-propyl]-1,3-propanediamine, [N,N-dimethyl-N′-(3-N-morpholinopropyl]-1,2-propanediamine, N,N-diethyl-N′-[1(dimethyl-aminoethyl]-1,4-pentane diamine, N,N-diethyl-N′-[2-ethyl-N″-morpholino]-1,3-propane-diamine, N,N-dimethyl-N′-[2-ethyl-N″-morpholino]-1,3-propanediamine, N,N-diethyl-N′-[2-ethyl-N″-pyrolidino]-1,3-propanediamine and N,N-diethyl-N′-[2-ethyl-N″-piperidinyl]-1,3-propanediamine.

18. A method as claimed in claim 16, wherein the triamine is selected from the group consisting of N,N-dimethyl-N′-[1(dimethylamino)-2-propyl]-1,2-ethanediamine, N,N-diethyl-N′-[1(dimethylamino)-2-propyl]-1,2-ethanediamine, 3(N.N-dimethylaminopropyl)imino-2-(N.N-dimethyl-propyl-amine), N,N-diethyl-N′-[1(dimethylamino)-2-propyl]-1,3-propanediamine, [N,N-dimethyl-N′-(3-N-morpholinopropyl]-1,2-propanediamine, N,N-diethyl-N′-[1(dimethyl-aminoethyl]-1,4-pentane diamine, N,N-diethyl-N′-[2-ethyl-N″-morpholino]-1,3-propane-diamine, N,N-dimethyl-N′-[2-ethyl-N″-morpholino]-1,3-propanediamine, N,N-diethyl-N′-[2-ethyl-N″-pyrolidino]-1,3-propanediamine and N,N-diethyl-N′-[2-ethyl-N″-piperidinyl]-1,3-propanediamine.

19. A method as claimed in claim 15, wherein the secondary amine function is bonded to at least one quaternary carbon or two tertiary carbons.

20. A method as claimed in claim 15, wherein the secondary amine function is bonded to at least one quaternary carbon or two tertiary carbons.

21. A method as claimed in claim 19, wherein the triamine is selected from the group consisting of N,N-diethyl-N′-[1(dimethylamino)-2-propyl]-1,4-pentanediamine, N,N-diethyl-N′-[1(dimethylamino)-3-butyl]-1,4-pentanediamine, N,N-diethyl-N′-[1(diethyl-amino)-3-butyl]-1,4-pentanediamine and N,N-diethyl-N′-[1(diethyl-amino)-2-methyl-3-pentyl]-1,4-pentanediamine.

22. A method as claimed in claim 20, wherein the triamine is selected from the group consisting of N,N-diethyl-N′-[1(dimethylamino)-2-propyl]-1,4-pentanediamine, N,N-diethyl-N′-[1(dimethylamino)-3-butyl]-1,4-pentanediamine, N,N-diethyl-N′-[1(diethyl-amino)-3-butyl]-1,4-pentanediamine and N,N-diethyl-N′-[1(diethyl-amino)-2-methyl-3-pentyl]-1,4-pentanediamine.

23. A method as claimed in claim 15, wherein the absorbent solution comprises between 10 and 60 wt. % triamine and between 10 and 90 wt. % water.

24. A method as claimed in claim 16, wherein the absorbent solution comprises between 10 and 60 wt. % triamine and between 10 and 90 wt. % water.

25. A method as claimed in claim 17, wherein the absorbent solution comprises between 10 and 60 wt. % triamine and between 10 and 90 wt. % water.

26. A method as claimed in claim 18, wherein the absorbent solution comprises between 10 and 60 wt. % triamine and between 10 and 90 wt. % water.

27. A method as claimed in claim 19, wherein the absorbent solution comprises between 10 and 60 wt. % triamine and between 10 and 90 wt. % water.

28. A method as claimed in claim 20, wherein the absorbent solution comprises between 10 and 60 wt. % triamine and between 10 and 90 wt. % water.

29. A method as claimed in claim 21, wherein the absorbent solution comprises between 10 and 60 wt. % triamine and between 10 and 90 wt. % water.

30. A method as claimed in claim 22, wherein the absorbent solution comprises between 10 and 60 wt. % triamine and between 10 and 90 wt. % water.

31. A method as claimed in claim 15, wherein the absorbent solution also comprises a non-zero proportion, below 20 wt. %, of an activating compound, said compound comprising a primary or secondary amine function.

32. A method as claimed in claim 16, wherein the absorbent solution also comprises a non-zero proportion, below 20 wt. %, of an activating compound, said compound comprising a primary or secondary amine function.

33. A method as claimed in claim 17, wherein the absorbent solution also comprises a non-zero proportion, below 20 wt. %, of an activating compound, said compound comprising a primary or secondary amine function.

34. A method as claimed in claim 19, wherein the absorbent solution also comprises a non-zero proportion, below 20 wt. %, of an activating compound, said compound comprising a primary or secondary amine function.

35. A method as claimed in claim 23, wherein the absorbent solution also comprises a non-zero proportion, below 20 wt. %, of an activating compound, said compound comprising a primary or secondary amine function.

36. A method as claimed in claim 31, wherein the activating compound is selected from the group consisting of:
MonoEthanolAmine,
N-butylethanolamine
Aminoethylethanolamine,
Diglycolamine,
Piperazine,
N-(2-hydroxyethyl)Piperazine,
N-(2-aminoethyl)Piperazine,
Morpholine,
3-(metylamino)propylamine.

37. A method as claimed in claim 15, wherein the absorbent solution also comprises a solvent selected from among methanol and sulfolane.

38. A method as claimed in claim 15, wherein the acid compound absorption is carried out at a pressure ranging between 1 bar and 120 bars, and at a temperature ranging between 20° C. and 100° C.

39. A method as claimed in claim 15, wherein performing regeneration of the absorbent solution laden with acid compounds, wherein at least one of heating, expansion and distillation, is carried out.

40. A method as claimed in claim 39, wherein the regeneration is carried out at a pressure ranging between 1 bar and 10 bars, and at a temperature ranging between 100° C. and 180° C.

41. A method as claimed in claim 15, wherein the gaseous effluent is selected from among natural gas, syngas, combustion fumes, refinery gas, Claus tail gases, biomass fermentation gases, cement plant gases and incinerator fumes.

42. A gas treating method as claimed in claim 17, comprising selectively removing H2S from a gaseous effluent containing H2S and CO2.
